(19) United States
(12) Patent Application Publication
(10) Pub. No.: US 2004/0207126 A1
(43) Pub. Date: Oct. 21, 2004

(54) Method for the production of fibres or a fibrous product in an electrostatic spinning method

(76) Inventor: Wolfgang Czado, Gefrees (DE)

Correspondence Address: FULBRIGHT & JAWORSKI, LLP, 1301 MCKINNEY, SUITE 5100, HOUSTON, TX, 77010-3095, US

(21) Appl. No.: 10/481,805

(22) PCT Filed: Jul. 23, 2002
(86) PCT No.: PCT/DE02/02704

(51) Int. Cl. B29C 47/00

(52) U.S. Cl. 264/465

(57) ABSTRACT

The subject of the invention is a process for the production of fibers or a fiber product in an electrostatic spinning process, wherein polymers are spun from solution and/or the melt and one or more oxidizable substances or substances with a π-electron system is or are added to the solution and/or the melt prior to the spinning operation.

The present invention relates to a process for the production of fibers or a fiber product in an electrostatic spinning process. The production of fibers or fiber products such as for example non-woven materials in an electrostatic spinning process has basically already been known for some time from the state of the art. Such processes provide that a polymer solution or a polymer melt is applied to an electrode and charged by a high electrical voltage. When now a counterpart electrode is moved into the proximity thereof, electrical forces act on the polymer solution or on the polymer melt and pull very fine fibers off that electrode. Various electrode and application apparatuses have already been described, for carrying out those processes. As representative examples mention will be made here of DE 20 32 072, EP 1 059 106, U.S. Pat. No. 3,994,258, U.S. Pat. No. 4,144,553, U.S. Pat. No. 4,323,525 and U.S. Pat. No. 4,287,139.

DE 20 32 072 already discloses that, when spinning a polymer solution in an electrostatic spinning process, the fiber diameter of the fibers produced can be influenced by the conductivity of the solution. In that case, fibers with a smaller fiber diameter are to be obtained with improved conductivity on the part of the polymer solution to be spun. In order to achieve that DE 20 32 072 discloses the addition of organic salts which can be converted into ions.

EP 1 059 106 also discloses additives for controlling charge, viscosity, surface tension and conductivity of a polymer melt or polymer solution to be spun in an electrostatic spinning process. However those additives serve expressly to improve spinning of the polymer solution or the polymer melt without resulting in a residual charge on or charging-up of the fibers produced. On the contrary, permanent electrical charging of the fibers or fiber products produced is to be avoided in accordance with the teaching of EP 1 059 106. That however is a disadvantage in terms of the use of those materials for filtering air as, without electrically charged fibers, it is only possible to mechanically separate off dust particles.

Therefore the object of the present invention is to develop the process as set forth in the opening part of this specification, to enrich the state of the art. Another object of the present invention is to develop such a process in such a fashion that the disadvantages known from the state of the art can be at least partially overcome in a technically simple and economic fashion, while the invention further seeks to provide that products with improved product properties can be obtained with that process.

The object of the invention is attained by a process having the features of accompanying claim 1 and by a use of fibers or fiber products produced in accordance with that process and having the features of claim 8. Advantage configurations of the invention are the subject-matter of claims 2 through 7.

In accordance with the invention the process set forth in the opening part of this specification is further developed in that polymers are spun from solution and/or from the melt and prior to the spinning operation one or more oxidizable substances or substances with a π-electron system are added to the solution and/or the melt, whereby the charge in the solution to be spun is advantageously increased and can be conserved in the fibers. In other words, the process according to the invention permits the production of electrically charged fibers or a fiber product consisting of such fibers, in an electrostatic spinning process. The products of the process according to the invention are preferably used in the manufacture of filter materials.

It is further preferred in that respect for the polymer solution or polymer melt to be sprayed from the anode, in which case the added substance or substances preferably at least stabilize a positive charge or said substances, in the appropriate solvent, have one or more oxidation potentials which can be determined by means of cyclic voltammetry.

In contrast to the state of the art in which the change in conductivity of the polymer liquid to be spun, for influencing the fiber diameter, is produced by the addition of salts which can be dissociated into ion pairs, the present invention is based on the realization that a substantial improvement in terms of process engineering becomes a possibility if a genuine charge excess on which the electrical field acts is produced in the polymer solution or melt to be spun.

Surprisingly it was found in that respect that it is basically much more effective to spray the solution from a positively charged nozzle onto a negatively charged counterpart electrode, than vice-versa. The reason for this is not yet completely settled. As most organic substances can be oxidized more easily than reduced however, it is assumed that the corresponding oxidation potentials of those substances are crucial in that respect. On the basis of that situation therefore a positive charge is to be introduced more effectively into the melt or solution to be spun.

To investigate that phenomenon for example bromothymol blue, methyl red, rhodamine B and crystal violet were cyclovoltammetrically measured in dichloromethane as a solvent, and with ferrocene as a reference. In that respect bromothymol blue has no oxidation potential in the measurement range which is accessible in dichloromethane. In full conformity with that investigation result, bromothymol blue was also found to be completely ineffective as an addition in dichloromethane, in accordance with the present invention. In contrast methyl red, rhodamine B and crystal violet have oxidation potential in the range of between 0.9 and 1.14 V and represent extremely effective representatives of the additives according to the invention. Even ferrocene itself with an oxidation potential of 0.38 V is an effective additive.

In the case of the present invention the interplay or the interactions of solvent and added substance are also of particular significance. That will be quite clear in making a transition to polar solvents such as tetrahydrofuran or butanone as the above-specified substances exhibit therein an even greater effect in accordance with the invention. That is generally attributed to the fact that ions are better stabilized in a solvent with a higher dielectric constant.

A comparable consideration also applies in regard to polymer melts as they behave like a solvent for the substances added in accordance with the invention.

The use of solvents with comparatively high dielectric constants such as particularly preferably for example butanone, acetonitrile, dimethylsulfoxide, water, dimethylformamide, n-methylformamide, acetone, ethanol and ethylene glycol makes it possible with the process according to the invention for electrostatic spinning to achieve process products which are even further improved. Preferably the fiber diameter of the fibers obtained with the process according to the invention can be adjusted by virtue of a suitable choice of the solvent and/or the added substances. In addition when implementing spinning from a solution the content of polymer therein may be suitably varied and in particular also increased. Also the polarity of the solvent can further be raised or increased by the addition of a substance with a very high dielectric constant. When dealing with a solution of polystyrene in dichloromethane or ethyl acetate that is possible for example by an addition of acetamide. It has been found however that it is not sufficient to increase the polarity of the solvent. Therefore a point of crucial significance for the present invention is that there is both a charge carrier and also a polar solvent which presumably stabilizes the charge carrier.

In accordance with a preferred embodiment the solvent with a comparatively high dielectric constant has a relative dielectric constant of at least 15.0 at a temperature of 20° C. Furthermore it is preferred for the substance or substances with a very high dielectric constant or constants, which is or are used to increase the polarity of the solvent, to respectively have a relative dielectric constant of at least 20.0, further preferably at least 30.0, at 20° C.

In conjunction with the above-mentioned polar solvents, astonishingly very many substances are suitable as charge carriers, which then do not necessarily have to have an oxidation potential.

A point of particular significance for use of the fibers produced in accordance with the process according to the invention or the fiber material produced in accordance with the process of the invention, for the production of air filters, is that they retain charges in a stable manner over a long period of time so that, besides purely mechanical separation of dust particles, they also permit electrostatic separation of dust particles. In particular substances have proven to be extremely effective additives for this purpose, which have large π-electron systems which can advantageously interact with amino groups or amino functions. Examples that may be mentioned are dyestuff derivatives of fuchsin, such as crystal violet and malachite green, rhodamines, azo dyes with additional amino groups such as methyl red and others such as for example auramine, safranine or oracet blue. Besides azo dyes, diazonium dyes, preferably diazo fast salts such as for example fast blue salt B and BB, fast violet salt B or fast red salt GG are also suitable. Equally charge transfer complexes such as for example comprising crystal violet and iodine or quinone and hydroquinone have proven to be effective in accordance with the present invention. Surprisingly a large part of the listed dyes are to be attributed to the basic or acid dyes, that is to say these involve salts of negatively or positively charged dye molecules. It is to be concluded therefrom that dye molecules which are charged from the outset already represent a particularly suitable additive in the process according to the invention.

In the case of these substances also it is possible to boost the action involved when using more strongly polar solvents or when using solvents with polarity-enhancing additives. In that respect it was unexpectedly found that substances with an extended π-electron system which is preferably resonance stabilized are particularly well suited as an additive in the process according to the invention if they contain functional groups such as amino, amido, imino, azo, nitro, carboxy, diazonium, hydroxy, thio, sulfo or halogen groups. They can however also be selected from the group of organic dyes, their precursors or derivatives, metalocenes and phthalocyanines as well as from the group of optical whitening agents such as for example Blankophor R.

The addition of the one or more substances to the polymer solution or polymer melt can be effected in accordance with the invention over a relatively wide range. Here the man skilled in the art will readily ascertain the required proportion by weight on the basis of the product properties which are wanted and which are aimed at, in the end product. Basically however it is preferable if the addition, in relation to one or more substances, is implemented in an amount of between 0.1 and 50% by weight of the polymer solution or polymer melt, more preferably in an amount of between 0.5 and 5% by weight.

With regard to the product properties of the fibers or fiber product produced by the process according to the invention it is to be noted that dyes frequently already cause comparatively intense coloration when used in very low levels of concentration. As, with the exception of uses in special areas, it is frequently desirable for air filters to be white or at best slightly colored, it is preferred in accordance with the invention if the substances added to the polymer solution or polymer melt are colorless. Alternatively it is preferable for the above-listed additives, if they are colored, to be so modified that they appear colorless, without in that respect losing their effect. Generally known chemical reaction procedures are available to the man skilled in the art for that purpose, such as for example alkylation, acylation, esterification, silylation, diazotization, oxidation or reaction with halogen, preferably with chlorine, or strong acids or bases, nitrogen oxides or sulfur oxides. Hydrogen halides such as for example hydrochloric acid gas or bases such as for example ammonia have particularly proved their worth here.

In principle all polymers which are spinnable from a solution or from the melt can be spun with the process according to the invention. Mention is to be made here in particular of polymers which are soluble in organic solvents such as polystyrene, polycarbonate, polyvinylchloride, polyacrylate, polymethacrylate, polyvinylacetate, polyvinylacetal, polyvinylether, polyurethane, polyamide, polysulfone, polyethersulfone, polyacrylonitrile, cellulose derivatives and mixtures and copolymers of those polymers. As thermoplastic materials mention is to be made here by way of example of polyolefins, polyesters, polyoxymethylene, polychlorotrifluoroethylene, polyphenylene sulfide, polyaryletherketone, polyvinylidene fluoride and mixtures and copolymers of those polymers. In addition the copolymers of polystyrene such as for example styrene/acrylonitrile copolymer, styrene/butadiene/styrene copolymer and acrylonitrile/butadiene/styrene copolymer have proven to be particularly suitable.

The present invention is described in greater detail hereinafter by means of examples which are intended to serve exclusively for better understanding of the invention and are not in any way intended to limit it.

### EXAMPLE

In a laboratory installation in which the polymer solution is urged very slowly from a 5 ml plunger syringe through a steel needle, a solution of 5% by weight of polystyrene in dichloromethane is added with between 0.5 and 2 g/l rhodamine G6. With a potential difference of between 15 and 50 kV at the electrodes, the result produced is fibers of a diameter of between about 200 and 1500 nm, wherein the maximum proportion is of a diameter of about 600 nm.

In that way 3 ml and more of polymer solution can be spun per hour with the process according to the invention. In contrast thereto, with the process known from the state of the art, it was only possible to spin 0.32 ml of polymer solution per hour. Equally it was not possible to electrostatically spin polystyrene solutions in dichloromethane with a proportion of less than 10% by weight. By virtue of the high level of concentration moreover the state of the art affords markedly thicker fibers of a diameter of about 20 μm. The present invention therefore makes it possible advantageously also to spin polymers in an electrostatic spinning process, which hitherto could not be spun or which hitherto could not be spun in levels of concentration of less than 10%. That is possible in particular with solutions of polystyrene, polycarbonate, polyacrylonitrile and polymethylmethacrylate, in which respect those polymers can also be spun at levels of concentration of below 10% by weight of polymer in the solution, in particular down to a concentration of about 3% by weight.

1. A process for the production of fibers or a fiber product in an electrostatic spinning process, wherein polymers are spun from solution and/or from the melt and one or more oxidizable substance(s) or substance(s) with a c-electron system and a polar solvent and/or a substance for enhancing the polarity of the solvent is or are added to the solution and/or the melt prior to the spinning operation, wherein the polymer solution or polymer melt is sprayed from the anode and the added oxidizable substance or substances or substance or substances with a π-electron system at least stabilize a positive charge so that after the spinning operation the fibers or the fiber product carries or carry an electrical charge.

2. A process as set forth in one of the preceding claims characterized in that the added oxidizable substance or substances or substance or substances with a π-electron system is/are selected from the group of organic dyes, preferably the basic or acid dyes, their precursors or derivatives, charge transfer complexes, metalocenes and phthalocyanines as well as optical whitening agents.

3. A process as set forth in one of the preceding claims characterized in that the added oxidizable substance or substances or substance or substances with a π-electron system has at least one functional group with charge-stabilizing properties, in particular amino, amido, imino, azo, diazonium, nitro, carboxy, hydroxy, thio, sulfo or halogen group.

4. A process as set forth in one of the preceding claims characterized in that the spinning operation is effected from a solution and the solvent used is in particular butanone, acetonitrile, dimethylsulfoxide, water, dimethylformamide, formamide, N-methylformamide, dichloromethane, ethyl acetate, acetone, ethanol and ethylene glycol.

5. A process as set forth in one of the preceding claims characterized in that the addition of the one or more oxidizable substance or substances or substance or substances with a π-electron system is effected in an amount of between 0.1 and 50% by weight of the polymer solution or polymer melt, preferably in an amount of between 0.5 and 5% by weight.

6. A process as set forth in one of the preceding claims characterized in that the added oxidizable substance or substances or substance or substances with a π-electron system are colorless.

7. A process as set forth in one of the claims 1 through 5 characterized in that the added oxidizable substance or substances or substance or substances with a π-electron system is/are decolored prior to the addition to the polymer solution or the polymer melt by chemical reaction, in particular by alkylation, acylation, esterification, silylation, diazotization, oxidation or by reaction with halogen, preferably with chlorine, or strong acids or bases, nitrogen oxides or sulfur oxides.

8. Use of fibers or a fiber product produced in accordance with a process as set forth in one of the preceding claims for the production of air filter media, in particular for the production of cabin air filters, circulatory air filters, clean room filters, exhaust air filters, living room filters or vacuum cleaner filters.
